(19) United States
(12) Patent Application Publication
(10) Pub. No.: US 2018/0078904 A1
(43) Pub. Date: Mar. 22, 2018

(54) FILTRATION APPARATUS

(71) Applicant: SUMITOMO ELECTRIC INDUSTRIES, LTD., Osaka-shi, Osaka (JP)

(72) Inventors: Hiromu TANAKA, Osaka (JP); Tomoyuki YONEDA, Osaka (JP); Hiroko MIKI, Osaka (JP); Toru MORITA, Osaka (JP)

(73) Assignee: SUMITOMO ELECTRIC INDUSTRIES, LTD., Osaka-shi, Osaka (JP)

(21) Appl. No.: 15/559,433

(22) PCT Filed: Apr. 25, 2016
(86) PCT No.: PCT/JP2016/062874

§ 371 Date: Sep. 19, 2017

(30) Foreign Application Priority Data
May 11, 2015 (JP) 2015-096301

(51) Int. Cl. B01D 65/02; B01D 63/04; B01D 71/36; C02F 1/44

(52) U.S. Cl. CPC B01D 65/02; B01D 63/04; C02F 2303/16; C02F 1/44; B01D 2321/185; B01D 71/36

(57) ABSTRACT

A filtration apparatus according to an embodiment of the present invention includes at least one filtration module including a plurality of hollow-fiber membranes arranged by being pulled in one direction and a pair of holding members that fix both ends of the plurality of hollow-fiber membranes, and at least one cleaning module that supplies air bubbles from below the filtration module. In the filtration apparatus, the filtration module has a structure in which the plurality of hollow-fiber membranes are arranged to form a curtain-like shape on the holding members each having a shape of a bar, and the holding members each have a plurality of regions in which the plurality of hollow-fiber membranes are densely arranged and which are disposed at intervals in a longitudinal direction.

### TECHNICAL FIELD

The present invention relates to a filtration apparatus.

### BACKGROUND ART

Filtration apparatuses including filtration modules that include bundles of a plurality of hollow-fiber membranes are used as solid-liquid separation treatment apparatuses in sewage treatment and processes for producing medicines or the like. Examples of such filtration modules include external pressure-type filtration modules in which the pressure on the outer circumferential side of the hollow-fiber membranes is increased so that a liquid to be treated is allowed to permeate into the inner circumferential side of the hollow-fiber membranes, immersion-type filtration modules in which a liquid to be treated is allowed to permeate into the inner circumferential side by the osmotic pressure or by a negative pressure on the inner circumferential side, and internal pressure-type filtration modules in which the pressure on the inner circumferential side of the hollow-fiber membranes is increased so that a liquid to be treated is allowed to permeate into the outer circumferential side of the hollow-fiber membranes.

Of the filtration modules described above, the external pressure-type filtration modules and the immersion-type filtration modules become contaminated because, for example, substances contained in the liquid to be treated adhere to the surfaces of the hollow-fiber membranes due to use. Accordingly, filtration capabilities of the filtration modules degrade if the filtration modules are left as they are. In view of this, a cleaning method (air scrubbing) has been employed with which air bubbles are supplied from below filtration modules so that the air bubbles scrub the surfaces of hollow-fiber membranes and cause the hollow-fiber membranes to vibrate to remove adhering substances (refer to Japanese Unexamined Patent Application Publication No. 2010-42329).

### CITATION LIST

### Patent Literature

PTL 1: Japanese Unexamined Patent Application Publication No. 2010-42329

### SUMMARY OF INVENTION

A filtration apparatus according to an embodiment of the present invention includes at least one filtration module including a plurality of hollow-fiber membranes arranged by being pulled in one direction and a pair of holding members that fix both ends of the plurality of hollow-fiber membranes, and at least one cleaning module that supplies air bubbles from below the filtration module. In the filtration apparatus, the filtration module has a structure in which the plurality of hollow-fiber membranes are arranged to form a curtain-like shape on the holding members each having a shape of a bar, and the holding members each have a plurality of regions in which the plurality of hollow-fiber membranes are densely arranged and which are disposed at intervals in a longitudinal direction.

### BRIEF DESCRIPTION OF DRAWINGS

FIG. 1 is a schematic view illustrating a filtration system including a filtration apparatus according to an embodiment of the present invention.

FIG. 2 is a schematic perspective view illustrating a cleaning module and a filtration module in a state of being held in the filtration apparatus in FIG. 1.

FIG. 3 is a schematic sectional view in the horizontal direction, the sectional view illustrating the filtration module in FIG. 2.

### DESCRIPTION OF EMBODIMENTS

### Technical Problem

In general, air bubbles for cleaning the surfaces of hollow-fiber membranes are continuously supplied to keep the surfaces of the hollow-fiber membranes clean. Therefore, when the cleaning efficiency at which the surfaces of the hollow-fiber membranes are cleaned by air bubbles decreases, the energy necessary for supplying air bubbles for cleaning may increase, and the filtration cost may increase. A solution for reducing this filtration cost is a method in which a plurality of filtration modules are connected together in a vertical direction. However, air bubbles may diffuse in holding members that hold hollow-fiber membranes (portions where the filtration modules are joined together), and the surfaces of the hollow-fiber membranes in an upper part may not come in contact with air bubbles. As a result, the cleaning efficiency may decrease.

A filtration apparatus according to the present invention has been made under the circumstances described above. An object of the present invention is to provide a filtration apparatus having good cleaning efficiency for hollow-fiber membrane surfaces.

### Advantageous Effects of the Present Disclosure

The filtration apparatus according to the present invention has good cleaning efficiency for hollow-fiber membrane surfaces.

### DESCRIPTION OF EMBODIMENT OF THE PRESENT INVENTION

A filtration apparatus according to an embodiment of the present invention includes at least one filtration module including a plurality of hollow-fiber membranes arranged by being pulled in one direction and a pair of holding members that fix both ends of the plurality of hollow-fiber membranes, and at least one cleaning module that supplies air bubbles from below the filtration module. In the filtration apparatus, the filtration module has a structure in which the plurality of hollow-fiber membranes are arranged to form a curtain-like shape on the holding members each having a shape of a bar, and the holding members each have a plurality of regions in which the plurality of hollow-fiber membranes are densely arranged and which are disposed at intervals in a longitudinal direction.

The filtration apparatus includes at least one filtration module having a structure in which a plurality of hollow-fiber membranes are arranged to form a curtain-like shape on holding members each having a shape of a bar, and the holding members each have a plurality of regions in which the plurality of hollow-fiber membranes are densely arranged and which are disposed at intervals in a longitudinal direction, thereby forming a plurality of dense bundles of the hollow-fiber membranes at intervals. Therefore, the filtration apparatus has spaces in which hollow-fiber membranes are not arranged, the spaces being disposed between adjacent dense bundles of the hollow-fiber membranes, and the dense bundles of the hollow-fiber membranes can freely vibrate in all directions. As a result, substances adhering to the surfaces of the hollow-fiber membranes can be shaken off by the vibration, and air bubbles supplied from at least one cleaning module can be guided to the inside of the dense bundles of the hollow-fiber membranes to accelerate the scrubbing effect due to the air bubbles. Accordingly, the filtration apparatus has good cleaning efficiency for the surfaces of the hollow-fiber membranes and can maintain high filtration efficiency.

A ratio of an average interval between the dense arrangement regions to an average length of the dense arrangement regions in the longitudinal direction is preferably 1/100 or more and 1 or less. When the ratio of the average interval between the dense arrangement regions to the average length of the dense arrangement regions in the longitudinal direction is within this range, the cleaning effect can be accelerated by shaking of the hollow-fiber membranes, and an unnecessary increase in the size of the filtration apparatus can be prevented.

A plurality of the filtration modules are preferably arranged in parallel at regular intervals. When a plurality of the filtration modules are arranged in parallel at regular intervals, spaces are uniformly formed also on both sides of each of the dense bundles of the hollow-fiber membranes in a direction in which the filtration modules are arranged, and the cleaning effect due to shaking of the hollow-fiber membranes can be further accelerated.

The plurality of hollow-fiber membranes arranged between the pair of holding members preferably have slack. When the plurality of hollow-fiber membranes arranged between the pair of holding members have slack, the hollow-fiber membranes can be shaken more reliably to accelerate the cleaning effect.

The hollow-fiber membranes preferably contain polytetrafluoroethylene as a main component. When the hollow-fiber membranes contain polytetrafluoroethylene as a main component, the hollow-fiber membranes have mechanical strength high enough to withstand shaking, and the cleaning efficiency due to air bubbles can be further improved.

Herein, the phrase “a shape of a bar” refers to a long and narrow shape and specifically means that the length in a longitudinal direction is four times or more the maximum width (maximum diameter) in a direction perpendicular to the longitudinal direction. The phrase “a plurality of hollow-fiber membranes are arranged to form a curtain-like shape” means that a plurality of hollow-fiber membranes are arranged so as to function as a partition wall between one direction and the other direction. The term “parallel” means that an angle formed by the two is 5° or less and preferably 3° or less. The term “regular intervals” means that the difference between each interval and an average interval is 10% or less and preferably 5% or less. The phrase “a hollow-fiber membrane has slack” means that a hollow-fiber membrane fixed between a pair of holding members is not in a state of tension, and specifically, means that when a portion of a hollow-fiber membrane between a pair of holding members is defined as an effective portion, the length of the effective portion (the length of the hollow-fiber membrane in the axial direction) is greater than the distance between the pair of holding members. The term “main component” refers to a component having a mass content of 50% or more and preferably 80% or more.

### Details of Embodiments of the Present Invention

A filtration apparatus 1 according to an embodiment of the present invention will now be described in detail with reference to the drawings.

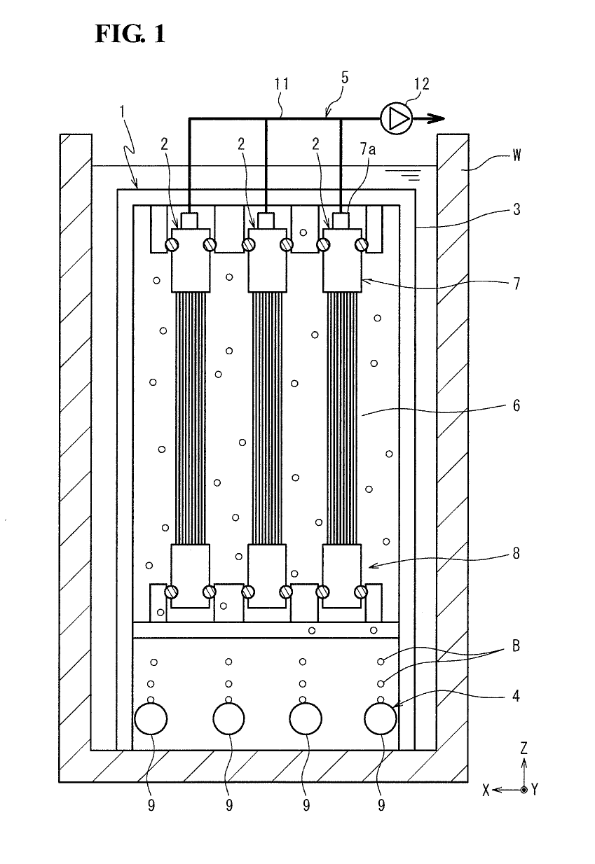

A filtration system illustrated in FIG. 1 includes a filtration vessel W that stores a liquid to be treated, i.e., a liquid to be filtered and a filtration apparatus 1 according to an embodiment of the present invention, the filtration apparatus 1 being disposed in the filtration vessel W. Hereinafter, in the description of FIG. 1, the upward-downward direction is defined as the Z direction, the left-right direction is defined as the X direction, and the depth direction in the drawing is defined as the Y direction.

### [Filtration Vessel]

The filtration vessel W stores a liquid to be treated so that the filtration apparatus 1 is immersed.

Examples of the material of the filtration vessel W include resins, metals, and concrete.

### [Filtration Apparatus]

The filtration apparatus 1 includes a plurality of filtration modules 2, a frame 3 that holds the filtration modules 2, a single cleaning module 4 that supplies air bubbles B from below the filtration modules 2, and a discharge mechanism 5 through which a treated liquid is discharged from the filtration modules 2, the treated liquid being obtained by filtering, with the filtration modules 2, the liquid to be treated.

### <Filtration Module>

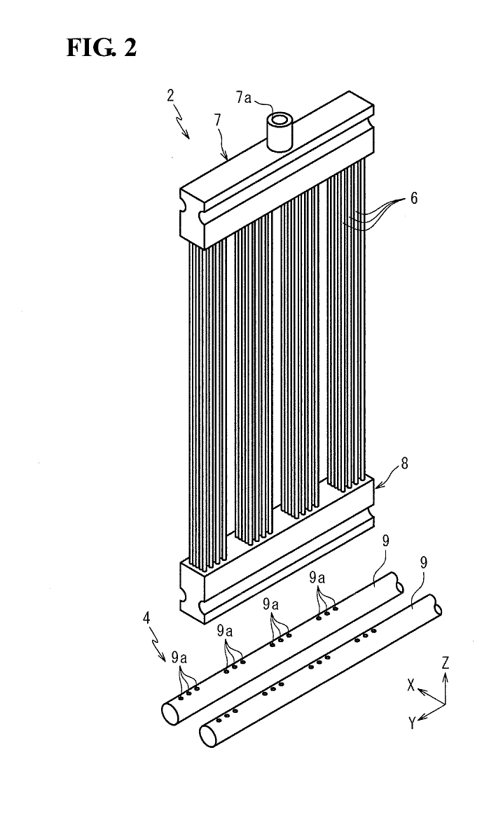

As illustrated in FIGS. 1 and 2, the filtration modules 2 each include a plurality of hollow-fiber membranes 6 that are arranged by being pulled in the upward-downward direction (Z direction), an upper holding member 7 that fixes upper ends of the hollow-fiber membranes 6, and a lower holding member 8 that is paired with the upper holding member 7 and that fixes lower ends of the hollow-fiber membranes 6.

In the filtration apparatus 1, the plurality of filtration modules 2 are each configured so that the upper holding member 7 and the lower holding member 8 are formed to have a shape of a long and narrow bar extending in the Y direction and the plurality of hollow-fiber membranes 6 are arranged to form a curtain-like shape along the longitudinal direction (Y direction) of the upper holding member 7 and the lower holding member 8. When the hollow-fiber membranes 6 are arranged to form a curtain-like shape, the air bubbles B can relatively easily enter the central portion of a curtain in the thickness direction (X direction) of the curtain formed by the hollow-fiber membranes 6. As a result, the cleaning effect achieved by the cleaning module 4, which will be described later, can be accelerated.

Furthermore, as illustrated in FIG. 2, the plurality of hollow-fiber membranes 6 are disposed so as to be divided into a plurality of dense bundles that are arranged densely, and the plurality of bundles of the hollow-fiber membranes 6 are aligned at intervals in the longitudinal direction (Y direction) of the upper holding member 7 and the lower holding member 8. Specifically, the upper holding member 7 and the lower holding member 8 each have a plurality of regions in which a plurality of hollow-fiber membranes 6 are densely arranged, the regions being disposed at intervals in the longitudinal direction of the upper holding member 7 and the lower holding member 8. When the hollow-fiber membranes 6 are divided into a plurality of dense bundles to provide gaps between the dense bundles of the hollow-fiber membranes 6, the dense bundles of the hollow-fiber membranes 6 can vibrate in the longitudinal direction of the upper holding member 7 and the lower holding member 8. As a result, substances adhering to the surfaces of the hollow-fiber membranes 6 can be shaken off by the vibration with high efficiency. In addition, since the gaps are present between the dense bundles of the hollow-fiber membranes 6, the air bubbles B can relatively easily enter the inside of the dense bundles of the hollow-fiber membranes 6 in the longitudinal direction of the upper holding member 7 and the lower holding member 8. As a result, the cleaning effect achieved by the cleaning module 4, which will be described later, can be further accelerated.

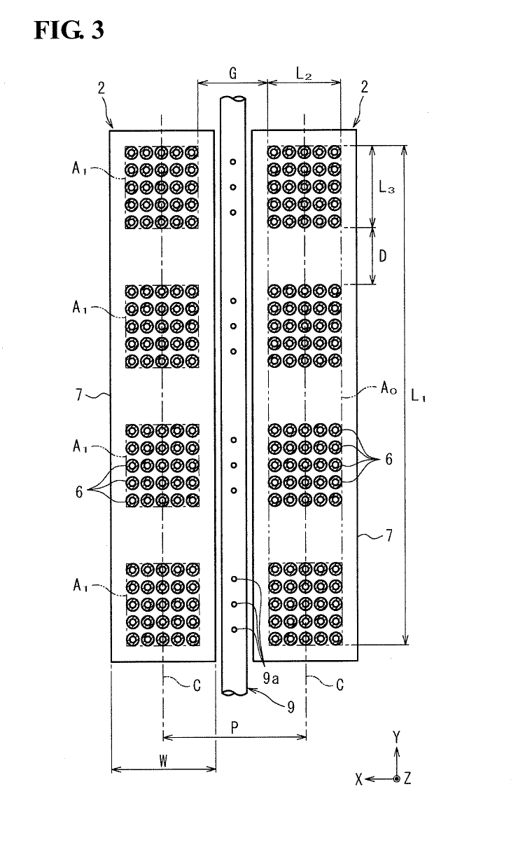

As illustrated in FIG. 3, a presence region A₀ of the hollow-fiber membranes 6 in the upper holding member 7 (and the lower holding member 8) of each of the filtration modules 2 in a direction (X-Y direction) perpendicular to the alignment direction (Z direction) includes a plurality of dense arrangement regions A₁ that are arranged in a line at intervals in the longitudinal direction (the Y direction, i.e., the upward-downward direction in the drawing) of the upper holding member 7. Herein, the term “presence region” refers to the smallest in area among imaginary convex polygons (polygons with all interior angles of less than 180°) that include all hollow-fiber membranes. In each of the dense arrangement regions A₁, the hollow-fiber membranes 6 are preferably arranged into a matrix in a longitudinal direction of the upper holding member 7 and the lower holding member 8 and a transverse direction (the X direction, i.e., the left-right direction in the drawing) perpendicular to the longitudinal direction. The presence region A₀ including the plurality of dense arrangement regions A₁ preferably has a rectangular shape in which a length L₁ in the longitudinal direction is greater than a length (width) L₂ in the transverse direction.

The lower limit of the ratio (L₃/L₂) of the average length L₃ of the dense arrangement regions A₁ in the presence region A₀ in the longitudinal direction to the average length L₂ of the presence region A₀ in the transverse direction is preferably 1/2 and more preferably 3/4. The upper limit of the ratio (L₃/L₂) of the average length L₃ of the dense arrangement regions A₁ in the longitudinal direction to the average length L₂ of the presence region A₀ in the transverse direction is preferably 10 and more preferably 5. When the ratio (L₃/L₂) of the average length L₃ of the dense arrangement regions A₁ in the longitudinal direction to the average length L₂ of the presence region A₀ in the transverse direction is less than the lower limit, the filtration area may become insufficient, and the size of the filtration apparatus 1 may be unnecessarily increased relative to the filtration capabilities of the apparatus. In contrast, when the ratio (L₃/L₂) of the average length L₃ of the dense arrangement regions A₁ in the longitudinal direction to the average length L₂ of the presence region A₀ in the transverse direction is more than the upper limit, cleaning of the hollow-fiber membranes 6 may not be sufficiently accelerated.

The lower limit of the ratio (D/L₃) of the average interval D between the dense arrangement regions A₁ to the average length L₃ of the dense arrangement regions A₁ in the presence region A₀ in the longitudinal direction is preferably 1/100 and more preferably 1/80. The upper limit of the ratio (D/L₃) of the average interval D between the dense arrangement regions A₁ to the average length L₃ of the dense arrangement regions A₁ in the longitudinal direction is preferably 1, more preferably 1/15, and still more preferably 1/20. When the ratio (D/L₃) of the average interval D between the dense arrangement regions A₁ to the average length L₃ of the dense arrangement regions A₁ in the longitudinal direction is less than the lower limit, cleaning of the hollow-fiber membranes 6 may not be sufficiently accelerated. In contrast, when the ratio (D/L₃) of the average interval D between the dense arrangement regions A₁ to the average length L₃ of the dense arrangement regions A₁ in the longitudinal direction is more than the upper limit, the filtration area may become insufficient, and the size of the filtration apparatus 1 may be unnecessarily increased relative to the filtration capabilities of the apparatus.

The lower limit of the average length L₁ of the presence region A₀ in the longitudinal direction is preferably 300 mm and more preferably 500 mm. The upper limit of the average length L₁ is preferably 1,200 mm and more preferably 1,000 mm. When the average length L₁ is less than the lower limit, sufficient filtration efficiency may not be obtained. In contrast, when the average length L₁ is more than the upper limit, it may become difficult to handle the filtration modules 2.

The lower limit of the average length L₂ of the presence region A₀ in the transverse direction is preferably 10 mm and more preferably 15 mm. The upper limit of the average length L₂ is preferably 100 mm and more preferably 75 mm. When the average length L₂ is less than the lower limit, sufficient filtration efficiency may not be obtained. In contrast, when the average length L₂ is more than the upper limit, the air bubbles B ejected from the cleaning module 4, which will be described later, may not be appropriately supplied to the central portions of the dense bundles of the hollow-fiber membranes 6.

The lower limit of the ratio (L₂/L) of the average length L₂ of the presence region A₀ in the transverse direction to the average length L₁ of the presence region A₀ in the longitudinal direction is preferably 1/80 and more preferably 1/50. The upper limit of the ratio (L₂/L) of the average length L₂ to the average length L₁ is preferably 1/3 and more preferably 1/10. When the ratio (L₂/L₁) of the average length L₂ to the average length L₁ is less than the lower limit, it may become difficult to handle the filtration modules 2. In contrast, when the ratio (L₂/L₁) of the average length L₂ to the average length L₁ is more than the upper limit, the air bubbles B ejected from the cleaning module 4 may not be appropriately supplied to the central portions of the dense bundles of the hollow-fiber membranes 6.

The lower limit of the average interval G between the presence regions A₀ of adjacent filtration modules 2 is preferably 10 mm and more preferably 15 mm. The upper limit of the average interval G between the presence regions A₀ is preferably 30 mm and more preferably 25 mm. When the average interval G between the presence regions A₀ is less than the lower limit, it may become difficult to appropriately introduce the air bubbles B ejected from the cleaning module 4, which will be described later, between the filtration modules 2. In contrast, when the average interval G between the presence regions A₀ is more than the upper limit, the size of the filtration apparatus 1 may be unnecessarily increased relative to the filtration capabilities of the apparatus.

The lower limit of the filling area ratio of the hollow-fiber membranes 6 in each of the dense arrangement regions A₁ is preferably 20% and more preferably 30%. The upper limit of the filling area ratio of the hollow-fiber membranes 6 in the dense arrangement region A₁ is preferably 60% and more preferably 55%. When the filling area ratio of the hollow-fiber membranes 6 is less than the lower limit, the number of hollow-fiber membranes 6 per unit area is decreased and sufficient filtration efficiency may not be obtained. In contrast, when the filling area ratio of the hollow-fiber membranes 6 is more than the upper limit, the gaps between the hollow-fiber membranes 6 become excessively small and the air bubbles B ejected from the cleaning module 4 may not be sufficiently supplied to the central portions of the dense bundles of the hollow-fiber membranes 6.

The lower limit of the number of hollow-fiber membranes 6 aligned in the transverse direction (the number of hollow-fiber membranes arranged in a row) in the presence region A₀ is preferably 8 and more preferably 12. The upper limit of the number of hollow-fiber membranes 6 arranged in the transverse direction is preferably 50 more preferably 40. When the number of hollow-fiber membranes 6 arranged in the transverse direction is less than the lower limit, the filtration efficiency per unit area may not be sufficiently obtained. In contrast, when the number of hollow-fiber membranes 6 arranged in the transverse direction is more than the upper limit, the air bubbles B ejected from the cleaning module 4 may not be appropriately supplied to the central portions of the dense bundles of the hollow-fiber membranes 6.

In the filtration apparatus 1, the plurality of filtration modules 2 are preferably arranged in parallel at regular intervals. Specifically, the filtration modules 2 are preferably held by the frame 3 such that central axes C of the planar shapes of the upper holding member 7 and the lower holding member 8 in the longitudinal direction are arranged in parallel at regular intervals. In this case, spaces are uniformly formed also on both sides of each dense bundle of the hollow-fiber membranes 6 in a direction in which the filtration modules are arranged. Thus, the cleaning effect due to shaking of the dense bundles of the hollow-fiber membranes 6 can be further accelerated.

The lower limit of the arrangement pitch P of the filtration modules 2 is preferably 1.1 times and more preferably 1.2 times the average width W of the lower holding member 8 in the horizontal direction. The upper limit of the arrangement pitch P of the filtration modules 2 is preferably 5 times and more preferably 2 times the average width W of the lower holding member 8. When the arrangement pitch P of the filtration modules 2 is less than the lower limit, the amount of air bubbles B capable of being supplied from the gap between the lower holding members 8 to the hollow-fiber membranes 6 may become insufficient. In contrast, when the arrangement pitch P of the filtration modules 2 is more than the upper limit, the size of the filtration apparatus 1 may be unnecessarily increased.

In a state where the filtration modules 2 are held by the frame 3, a plurality of hollow-fiber membranes 6 arranged between the pair of holding members 7 and 8 preferably have slack. Specifically, an average effective length of the hollow-fiber membranes 6 (a length of the hollow-fiber membranes 6 along the central axes) is preferably greater than an average distance between two ends of effective portions (the distance between the center of the lower surface of a portion of the upper holding member 7 and the center of the upper surface of a portion of the lower holding member 8, the portions each holding the hollow-fiber membranes 6) so that a force in the upward direction due to the tension of the hollow-fiber membranes 6 does not act on the lower holding member 8.

When the hollow-fiber membranes 6 have slack in this manner, the air bubbles B easily enter the inside of the dense bundles of the hollow-fiber membranes 6, and the hollow-fiber membranes 6 shake and thus the cleaning effect can be accelerated by the vibration.

When the hollow-fiber membranes 6 are in a state of tension, effective portions of the hollow-fiber membranes 6 (portions between the upper holding member 7 and the lower holding member 8) extend substantially linearly. In contrast, when the hollow-fiber membranes 6 have slack, the hollow-fiber membranes 6 deviate from straight lines connecting the two ends of the effective portions and are in a state of being bent. Accordingly, the magnitude of the slack of a hollow-fiber membrane 6 can be represented as the ratio of the effective length of the hollow-fiber membrane 6 to the linear distance between the two ends of the effective portion of the hollow-fiber membrane 6 (as an example that is easy to understand, the ratio of the length of the chord to the length of the circular arc when the effective portion of the hollow-fiber membrane 6 is bent in the shape of a circular arc). The lower limit of the ratio of the average effective length to the average linear distance between the two ends of the effective portions of the hollow-fiber membranes 6 is preferably 1.01 and more preferably 1.02. The upper limit of the ratio of the average effective length to the average linear distance between the two ends of the effective portions of the hollow-fiber membranes 6 is preferably 1.2 and more preferably 1.1. When the ratio of the average effective length to the average linear distance between the two ends of the effective portions of the hollow-fiber membranes 6 is less than the lower limit, the amount capable of shaking the hollow-fiber membranes 6 is small, and the cleaning acceleration effect due to entry of the air bubbles B into the inside of the bundles of the hollow-fiber membranes 6 and vibration of the hollow-fiber membranes 6 may not be sufficiently obtained. In contrast, when the ratio of the average effective length to the average linear distance between the two ends of the effective portions of the hollow-fiber membranes 6 is more than the upper limit, the hollow-fiber membranes 6 may be intertwined with each other and cleaning may be hindered.

### <Cleaning Module>

As illustrated in FIGS. 1 and 2, the cleaning module 4 is arranged below the plurality of filtration modules 2. The cleaning module 4 includes a plurality of gas supply pipes 9 that are arranged between the filtration modules 2 in plan view and that supply air. The gas supply pipes 9 each have a plurality of air-bubble ejection openings 9a through which air bubbles are ejected, the air-bubble ejection openings 9a being located, in plan view, at positions corresponding to the dense arrangement regions A₁ of the lower holding member 8 in the longitudinal direction (Y direction). More specifically, as illustrated in FIG. 3, the air-bubble ejection openings 9a are opened between the dense arrangement regions A₁ of the filtration modules 2 that are adjacent to each other in the X direction in plan view. When the air-bubble ejection openings 9a are arranged in this manner, air bubbles pass through the gaps between the lower holding members 8 and come in contact with the hollow-fiber membranes 6 with high efficiency. Therefore, the cleaning effect of the hollow-fiber membranes 6 can be accelerated. The diameter of each of the air-bubble ejection openings 9a is, for example, 1 mm or more and 10 mm or less.

### <Discharge Mechanism>

The discharge mechanism 5 includes a water-collecting pipe 11 that is connected to drainage nozzles 7a of the filtration modules 2 and that collects a treated liquid obtained by filtering, through the hollow-fiber membranes 6, a liquid to be treated and a suction pump 12 that suctions the treated liquid from the water-collecting pipe 11.

### <Hollow-Fiber Membrane>

The hollow-fiber membranes 6 of the filtration modules 2 are prepared by forming porous membranes into tubes, the porous membranes allowing permeation of a liquid while blocking permeation of impurities contained in a liquid to be treated.

The hollow-fiber membranes 6 may contain a thermoplastic resin as a main component. Examples of the thermoplastic resin include polyethylene, polypropylene, polyvinylidene fluoride, ethylene-vinyl alcohol copolymers, polyamides, polyimides, polyetherimide, polystyrene, polysulfones, polyvinyl alcohol, polyphenylene ether, polyphenylene sulfide, cellulose acetate, polyacrylonitrile, and polytetrafluoroethylene (PTFE). Of these, PTFE, which has good mechanical strength, chemical resistance, heat resistance, weather resistance, and flame resistance and is porous, is preferable and uniaxially or biaxially stretched PTFE is more preferable. The material for forming the hollow-fiber membranes 6 may contain, for example, other polymers and additives such as a lubricant, as required.

The lower limit of the ratio of the average pitch of the arrangement of the hollow-fiber membranes 6 in the transverse direction (X direction) to the average outer diameter of the hollow-fiber membranes 6 is preferably 1. The upper limit of the ratio of the average pitch in the short-side direction to the average outer diameter of the hollow-fiber membranes 6 is preferably 3/2 and more preferably 7/5. When the ratio of the average pitch of the arrangement in the transverse direction to the average outer diameter of the hollow-fiber membranes 6 is less than the lower limit, the hollow-fiber membranes 6 are arranged in a squashed state in the radial direction, and therefore, it may become difficult to produce the filtration modules 2. In contrast, when the ratio of the average pitch of the arrangement in the transverse direction to the average outer diameter of the hollow-fiber membranes 6 is more than the upper limit, the density of the hollow-fiber membranes 6 in the transverse direction is decreased and thus sufficient filtration efficiency may not be obtained.

The lower limit of the average outer diameter of the hollow-fiber membranes 6 is preferably 1 mm, more preferably 1.5 mm, and still more preferably 2 mm. The upper limit of the average outer diameter of the hollow-fiber membranes 6 is preferably 6 mm, more preferably 5 mm, and still more preferably 4 mm. When the average outer diameter of the hollow-fiber membranes 6 is less than the lower limit, the mechanical strength of the hollow-fiber membranes 6 may become insufficient. In contrast, when the average outer diameter of the hollow-fiber membranes 6 is more than the upper limit, flexibility of the hollow-fiber membranes 6 becomes insufficient and vibration or shaking of the hollow-fiber membranes 6 caused by contact with the air bubbles B may become thereby insufficient. Consequently, the gaps between the hollow-fiber membranes 6 may not expand, and the air bubbles B may not be guided to the central portions of the dense bundles of the hollow-fiber membranes 6. In addition, the ratio of the surface area to the cross-sectional area of the hollow-fiber membranes 6 may become small and the filtration efficiency may thereby decrease.

The lower limit of the average effective length of the hollow-fiber membranes 6 is preferably 1 m and more preferably 2 m. The upper limit of the average effective length of the hollow-fiber membranes 6 is preferably 6 m and more preferably 5 m. When the average effective length of the hollow-fiber membranes 6 is less than the lower limit, shaking of the hollow-fiber membranes 6 caused by scrubbing with the air bubbles B becomes insufficient, and the gaps between the hollow-fiber membranes 6 may not expand and the air bubbles B may not be guided to the central portions of the dense bundles of the hollow-fiber membranes 6. In contrast, when the average effective length of the hollow-fiber membranes 6 is more than the upper limit, the hollow-fiber membranes 6 may be subjected to excessive bending due to the own weight of the hollow-fiber membranes 6, and handleability during, for example, installation of the filtration modules 2 may be decreased.

The lower limit of the ratio (aspect ratio) of the average effective length to the average outer diameter of the hollow-fiber membranes 6 is preferably 150 and more preferably 1,000. The upper limit of the aspect ratio of the hollow-fiber membranes 6 is preferably 6,000 and more preferably 5,000. When the aspect ratio of the hollow-fiber membranes 6 is less than the lower limit, shaking of the hollow-fiber membranes 6 caused by scrubbing with the air bubbles B becomes insufficient, and the gaps between the hollow-fiber membranes 6 may not expand and the air bubbles B may not be guided to the central portions of the dense bundles of the hollow-fiber membranes 6. In contrast, when the aspect ratio of the hollow-fiber membranes 6 is more than the upper limit, the hollow-fiber membranes 6 are excessively long and narrow and thus mechanical strength may decrease when the hollow-fiber membranes 6 are held taut in the upward-downward directions.

### <Upper Holding Member>

The upper holding member 7 has a drainage nozzle 7a which forms an inner space that communicates with inner cavities of the holding hollow-fiber membranes 6 and through which treated water, which has been filtered through the hollow-fiber membranes 6, is discharged from the inner space.

The lower limit of the ratio of the average width of the upper holding member 7 in the X direction in plan view (average width of a shape projected in the vertical direction, the average width extending in the transverse direction) to the average width of the presence region A₀ of the hollow-fiber membranes 6 in the X direction is preferably 1.05 and more preferably 1.1. The upper limit of the ratio of the average width of the upper holding member 7 in plan view to the average width of the presence region A₀ of the hollow-fiber membranes 6 is preferably 1.3 and more preferably 1.2. When the ratio of the average width of the upper holding member 7 in plan view to the average width of the presence region A₀ of the hollow-fiber membranes 6 is less than the lower limit, the strength of the upper holding member 7 may become insufficient. In contrast, when the ratio of the average width of the upper holding member 7 in plan view to the average width of the presence region A₀ of the hollow-fiber membranes 6 is more than the upper limit, the gap between the upper holding members 7 is decreased, and the air bubbles B after the cleaning of the hollow-fiber membranes 6 may not be smoothly discharged upward. In addition, the gap between dense bundles of the hollow-fiber membranes 6 that are arranged to form a curtain-like shape cannot be decreased, and the size of the filtration apparatus 1 may be unnecessarily increased.

### <Lower Holding Member>

The lower holding member 8 holds lower ends of the hollow-fiber membranes 6. The lower holding member 8 may form an inner space as in the upper holding member 7. Alternatively, the lower holding member 8 may hold the lower ends of the hollow-fiber membranes 6 in such a manner that the openings of the hollow-fiber membranes 6 are closed. The average width of the lower holding member 8 in the X direction in plan view may be the same as that of the upper holding member 7.

### <Frame>

As described above, the frame 3 holds the upper holding members 7 and the lower holding members 8 of the plurality of filtration modules 2, thereby arranging the filtration modules 2 in a state of immersion in a liquid to be treated, the liquid being stored in the filtration vessel W.

The frame 3 is preferably configured so as to be taken out from the filtration vessel W in a state of holding the filtration modules 2. In addition, the frame 3 is preferably configured so as to hold the cleaning module 4, which will be described later, below the filtration modules 2.

### Advantages

The filtration apparatus 1 has spaces between the dense bundles of the hollow-fiber membranes 6, and the dense bundles of the hollow-fiber membranes 6 can vibrate freely. Therefore, substances adhering to the surfaces of the hollow-fiber membranes can be shaken off by the vibration, and the air bubbles B supplied from the cleaning module 4 can be guided to the inside of the dense bundles of the hollow-fiber membranes 6 to accelerate the scrubbing effect due to the air bubbles B. Accordingly, the filtration apparatus 1 has good cleaning efficiency for the surfaces of the hollow-fiber membranes 6 and can maintain high filtration efficiency.

### Other Embodiments

It is to be understood that the embodiments disclosed herein are only illustrative and are not restrictive in all respects. The scope of the present invention is not limited to the configurations of the embodiments and is defined by the claims described below. The scope of the present invention is intended to cover all the modifications within the meaning and the scope of equivalents of the claims.

In the filtration apparatus, the filtration modules need not be necessarily arranged in parallel, and the interval between the filtration modules may be non-uniform.

In the filtration apparatus, the cleaning module may supply air bubbles from positions that do not correspond to the dense arrangement regions. For example, the cleaning module may include gas supply pipes having air-bubble ejection openings disposed at a regular pitch irrelevant to the dense arrangement regions. Alternatively, the cleaning module may supply air bubbles from air-bubble ejection openings that are opened directly under the dense arrangement regions.

In the filtration apparatus, the cleaning module may have any structure capable of supplying air bubbles from below the filtration modules. For example, a jet-type gas diffuser that jets air bubbles from a diffuser, a sparger, or the like or a bubbling jet nozzle that jets a water stream mixed with air bubbles may be used. The filtration apparatus may include a plurality of cleaning modules.

In the filtration apparatus, the cleaning module may include a gas supply pipe through which air is supplied and a plurality of intermittent air bubble generators that accumulate the air supplied from the gas supply pipe and that release, at one time, the air accumulated in a particular amount or more. The intermittent air bubble generators may each be an air release mechanism used in an intermittent air pumping cylinder or the like described in, for example, Japanese Unexamined Patent Application Publication No. 58-70895. Such a plurality of intermittent air bubble generators are preferably disposed at positions corresponding to the dense arrangement regions in the longitudinal direction of the lower holding member in plan view. Coarse air bubbles ejected from the intermittent air bubble generators substantially play a role of a comb that combs the dense bundles of the hollow-fiber membranes so as to move the slack of the hollow-fiber membranes upward. Accordingly, since the coarse air bubbles ejected from the intermittent air bubble generators can scrub the surfaces of the hollow-fiber membranes with high efficiency and cause the hollow-fiber membranes forming the dense bundles to vibrate at one time, substances, such as activated sludge, adhering to the surfaces of the hollow-fiber membranes can be removed with high efficiency.

The filtration apparatus may be used as various filtration apparatuses such as external pressure-type filtration apparatuses in which the pressure on the outer circumferential side of hollow-fiber membranes is increased so that a liquid to be treated is allowed to permeate into the inner circumferential side of the hollow-fiber membranes, immersion-type filtration apparatuses in which a liquid to be treated is allowed to permeate into the inner circumferential side by osmotic pressure or by a negative pressure on the inner circumferential side, and internal pressure-type filtration apparatuses in which the pressure on the inner circumferential side of hollow-fiber membranes is increased so that a liquid to be treated is allowed to permeate into the outer circumferential side of the hollow-fiber membranes.

### REFERENCE SIGNS LIST

1 filtration apparatus
2 filtration module
3 frame
4 cleaning module
5 discharge mechanism
6 hollow-fiber membrane
7 upper holding member
7a drainage nozzle
8 lower holding member
9 gas supply pipe
9a air-bubble ejection opening
11 water-collecting pipe
12 suction pump
A₀ presence region
A₁ dense arrangement region
B air bubble
C central axis in longitudinal direction
D interval between dense arrangement regions
G interval between lower holding members
L₁ length of presence region in longitudinal direction
L₂ length of presence region in transverse direction
L₃ length of dense arrangement region in longitudinal direction
P arrangement pitch of filtration modules
W filtration vessel

1: A filtration apparatus comprising:
at least one filtration module including a plurality of hollow-fiber membranes arranged by being pulled in one direction and a pair of holding members that fix both ends of the plurality of hollow-fiber membranes; and
at least one cleaning module that supplies air bubbles from below the filtration module,
wherein the filtration module has a structure in which the plurality of hollow-fiber membranes are arranged to form a curtain-like shape on the holding members each having a shape of a bar, and
the holding members each have a plurality of dense arrangement regions in which the plurality of hollow-fiber membranes are densely arranged and which are disposed at intervals in a longitudinal direction.

2: The filtration apparatus according to claim 1, wherein a ratio of an average interval between the dense arrangement regions to an average length of the dense arrangement regions in the longitudinal direction is 1/100 or more and 1 or less.

3: The filtration apparatus according to claim 1, wherein a plurality of the filtration modules are arranged in parallel at regular intervals.

4: The filtration apparatus according to claim 1, wherein the plurality of hollow-fiber membranes arranged between the pair of holding members have slack.

5: The filtration apparatus according to claim 4, wherein a ratio of an average effective length of the hollow-fiber membranes to an average linear distance between both ends of effective portions of the hollow-fiber membranes is 1.01 or more and 1.2 or less.

6: The filtration apparatus according to claim 1, wherein the hollow-fiber membranes contain polytetrafluoroethylene as a main component.
